(19) United States
(12) Patent Application Publication
(10) Pub. No.: US 2025/0166981 A1
(43) Pub. Date: May 22, 2025

(54) Data Processing Method, Computer Readable Medium, Information Processing Apparatus, and Gas Chromatograph Mass Spectrometer

(71) Applicant: SHIMADZU CORPORATION, Kyoto-shi (JP)

(72) Inventor: Shota MATSUNAGA, Kyoto-shi (JP)

(21) Appl. No.: 18/923,388

(22) Filed: Oct. 22, 2024

(30) Foreign Application Priority Data
Nov. 16, 2023 (JP) 2023-195179

(51) Int. Cl. H01J 49/00; G01N 30/02; G01N 30/72; G01N 30/86

(52) U.S. Cl. CPC H01J 49/0036; G01N 30/7206; G01N 30/8631; G01N 2030/025

(57) ABSTRACT

A data processing method according to the present disclosure sets based on a first collection condition associated with a first separation condition, a second collection condition associated with a second separation condition. The data processing method according to the present disclosure includes calculating predicted retention time of each target component under the second separation condition, setting timings to start and quit collection of data under the second collection condition, and causing a chromatograph mass spectrometer to separate a sample under the second separation condition and to collect data on the target component under the second collection condition.

### CROSS REFERENCE TO RELATED APPLICATIONS

This nonprovisional application is based on Japanese Patent Application No. 2023-195179 filed with the Japan Patent Office on Nov. 16, 2023, the entire contents of which are hereby incorporated by reference.

### BACKGROUND OF THE INVENTION

### Field of the Invention

The present disclosure relates to a data processing method, a computer readable medium, an information processing apparatus, and a gas mass chromatograph spectrometer, and more particularly to a technology to improve accuracy in measurement of a component by a mass spectrometer.

### Description of the Background Art

In analysis with the use of a chromatograph mass spectrometer, components in a sample are separated over time in a column in a chromatograph, the components are ionized in a mass spectrometry portion, and mass spectra are obtained. Prior to the analysis, a user sets a condition (separation condition) for separation in the chromatograph and a condition (collection condition) for mass spectrometry of separated components.

For example, analysis with the use of a gas chromatograph mass spectrometry (GCMS) apparatus in which gas chromatograph (GC) and mass spectrometry (MS) are combined will be described as the analysis by way of example. Initially, the user sets the separation condition in GC. The separation condition includes, for example, a column to be used, a temperature of a column oven, and a type of carrier gas. The separation condition is set in conformity with a sample to be analyzed by the user. As the sample is introduced into the GC, components in the sample are separated over time in accordance with the set separation condition and introduced into an MS portion.

The user sets the collection condition in the MS portion in conformity with the separation condition. Scan measurement and selective ion monitoring (SIM) measurement have been known in relation to the collection condition set for GCMS. Scan measurement is a measurement method of repeatedly scanning a mass number within a range of prescribed mass numbers, and all ions included in the range of the mass numbers are detected. SIM measurement, on the other hand, is a measurement method of selectively detecting only ions having a specific mass number designated in advance. In SIM measurement, only ions having a prescribed mass number can be detected, however, accuracy in measurement can be improved. Prior to measurement, the user should set as the collection condition, timing to start and timing to quit scan measurement and/or SIM measurement as well as the mass number of ions to be measured in a case of selection of SIM measurement. Timing to start and timing to quit each measurement are set, for example, based on time elapsed since a time point of injection of the sample into the GC. In other words, the user should set the collection condition in consideration of timing of introduction into the MS portion, of each component separated in accordance with the set separation condition.

In GCMS, when the separation condition is changed, timing of introduction of components into the MS portion is varied. Specifically, timing to start and timing to quit measurement set in the collection condition may deviate from timing of actual introduction into the MS portion, of components of interest in the collection condition. Therefore, when the separation condition is changed, the user should reset the collection condition in conformity with the changed separation condition. The user can manually reset the collection condition. When there are many components of interest, however, time for works required for resetting by the user may be long. Therefore, a technology to automatically set the collection condition corresponding to the changed separation condition based on the separation condition before change and the collection condition corresponding thereto has been proposed. For example, in connection with resetting of the collection condition, Japanese Patent Laying-Open No. 2006-322842 (Japanese Patent Laying-Open No. 2006-322842) discloses a gas chromatograph mass spectrometer that predicts time of elution of components to be measured based on mobility of a reference compound and automatically resets the collection condition based on the prediction.

### SUMMARY OF THE INVENTION

In Japanese Patent Laying-Open No. 2006-322842, the gas chromatograph mass spectrometer sets with a mathematical technique, timing to start and timing to quit measurement under the collection condition based on the mobility of the reference compound in a new separation condition. For example, when intervals of elution of the reference compound become shorter, however, timing to start and timing to quit measurement under the collection condition are set to make the intervals between the timing to start and timing to quit measurement shorter and some of all peaks of components of interest may be out of a range of measurement under the set collection condition. In such a case, some of components of interest eluted from the GC cannot be measured in the MS portion and hence accuracy in measurement may be lowered.

A retention index may be used for calculation of predicted retention time to be used in resetting of the collection condition. The retention index is a relative value not dependent on the separation condition, and it is used for calculation of the predicted retention time as being combined with a retention time of the reference compound. The collection condition, however, may not be reset as intended by the user, because the collection condition was automatically set based on the predicted retention time estimated with the use of the retention index by the user. In such a case, all of components of interest are not eluted from a chromatograph between timing to start and timing to end the reset collection condition, and hence accuracy in measurement may be lowered.

The present disclosure was made in view of such circumstances, and an object thereof is to provide a technology to automatically reset a collection condition without the use of a retention index, in accordance with change of a separation condition in chromatograph mass spectrometry and to improve accuracy in measurement under the changed separation condition.

A data processing method according to a first aspect of the present disclosure relates sets based on a first collection condition associated with a first separation condition, a second collection condition associated with a second separation condition, for a chromatograph mass spectrometer that separates a sample containing one or more target components and collects data on the sample. The first collection condition includes a first start timing to start collection of the data and a first end timing to quit collection of the data. The first start timing is a time point that goes back by a first period from an earliest retention time, of retention times of the one or more target components under the first separation condition. The first end timing is a time point after lapse of a second period since a latest retention time, of the retention times. The second collection condition includes a second start timing to start collection of the data and a second end timing to quit collection of the data. The second start timing is timing to start collection of the data under the second collection condition. The second end timing is timing to quit collection of the data under the second collection condition. The data processing method includes calculating predicted retention times of the one or more target components under the second separation condition based on a result of separation of a standard sample under the second separation condition, setting timing before a first time point as the second start timing, the first time point being a time point that goes back by the first period from an earliest predicted retention time of the predicted retention times, setting timing after a second time point as the second end timing, the second time point being a time point after lapse of the second period since a latest predicted retention time of the predicted retention times, and causing the chromatograph mass spectrometer to separate the sample under the second separation condition and to collect data on the one or more target components under the second collection condition.

A computer readable medium according to a second aspect of the present disclosure is a non-transitory computer readable medium having a program recorded thereon, the program being executed by a processor mounted on a computer. The program, by being executed by the processor, causes the computer to perform accepting a first collection condition, the first collection condition being a data collection condition under a first separation condition, the first collection condition including a first start timing to start collection of data and a first end timing to quit collection of data, the first start timing being a time point that goes back by a first period from an earliest retention time, of retention times of the one or more target components under the first separation condition, the first end timing being a time point after lapse of a second period since a latest retention time, of the retention times, calculating predicted retention times of the one or more target components under a second separation condition based on a result of separation of a standard sample under the second separation condition, setting timing before a first time point as the second start timing, the first time point being a time point that goes back by the first period from an earliest predicted retention time of the predicted retention times, the second start timing being timing to start collection of the data under the second collection condition associated with the second separation condition, and setting timing after a second time point as the second end timing, the second time point being a time point after lapse of the second period since a latest predicted retention time of the predicted retention times, the second end timing being timing to quit collection of the data under the second collection condition.

A gas chromatograph mass spectrometer according to a third aspect of the present disclosure is a gas chromatograph mass spectrometer that sets based on a first collection condition which is a data collection condition for collection of data on one or more target components under a first separation condition, a second collection condition and collects data, the second collection condition being a data collection condition under a second separation condition under which a sample containing the one or more target components is to be analyzed. The first collection condition includes a first start timing to start collection of the data and a first end timing to quit collection of the data. The first start timing is a time point that goes back by a first period from an earliest retention time, of retention times of the one or more target components under the first separation condition. The first end timing is a time point after lapse of a second period since a latest retention time, of the retention times. The second collection condition includes a second start timing to start collection of the data and a second end timing to quit collection of the data. The second start timing is timing to start collection of the data under the second collection condition. The second end timing is timing to quit collection of the data under the second collection condition. The gas chromatograph mass spectrometer includes a gas chromatograph, a mass spectrometer that conducts mass spectrometry of a component separated by the gas chromatograph, and a controller that controls the gas chromatograph and the mass spectrometer. The gas chromatograph is configured to separate a standard sample containing an already-known prescribed component under the second separation condition. The mass spectrometer is configured to analyze the prescribed component and obtain a chromatogram. The controller is configured to (a) calculate predicted retention times of the one or more target components under the second separation condition based on a result of separation of the standard sample under the second separation condition, (b) set timing before a first time point as the second start timing, the first time point being a time point that goes back by the first period from an earliest predicted retention time of the predicted retention times, (c) set timing after a second time point as the second end timing, the second time point being a time point after lapse of the second period since a latest predicted retention time of the predicted retention times, and (d) cause the gas chromatograph to separate the sample into components under the second separation condition and to obtain data on the one or more target components under the second collection condition.

The foregoing and other objects, features, aspects and advantages of this invention will become more apparent from the following detailed description of this invention when taken in conjunction with the accompanying drawings.

### BRIEF DESCRIPTION OF THE DRAWINGS

FIG. 1 is a schematic diagram of a GCMS apparatus according to an embodiment.

FIG. 2 is a diagram showing a hardware configuration of a controller according to the embodiment.

FIG. 3 is a diagram for illustrating a method of setting a collection condition in the GCMS apparatus.

FIG. 4 is a diagram for illustrating a method of changing the collection condition when a separation condition in a comparative example is changed.

FIG. 5 is a diagram for illustrating a method of modifying the collection condition based on a retention index in the comparative example.

FIG. 6 is a diagram for illustrating a method of setting a new collection condition with change of the separation condition.

FIG. 7 is a diagram for illustrating a result of modification of the collection condition with the method of modifying the collection condition according to the embodiment.

FIG. 8 is a diagram for illustrating information inputted by a user, in which a compound to be measured and the collection condition are associated with each other.

FIG. 9 is a flowchart showing analysis processing performed by the GCMS apparatus according to the embodiment.

### DESCRIPTION OF THE PREFERRED EMBODIMENTS

An embodiment of the present disclosure will be described in detail below with reference to the drawings. The same or corresponding elements in the drawings have the same reference characters allotted below and description thereof will not be repeated.

### [Overall Configuration of GCMS Apparatus]

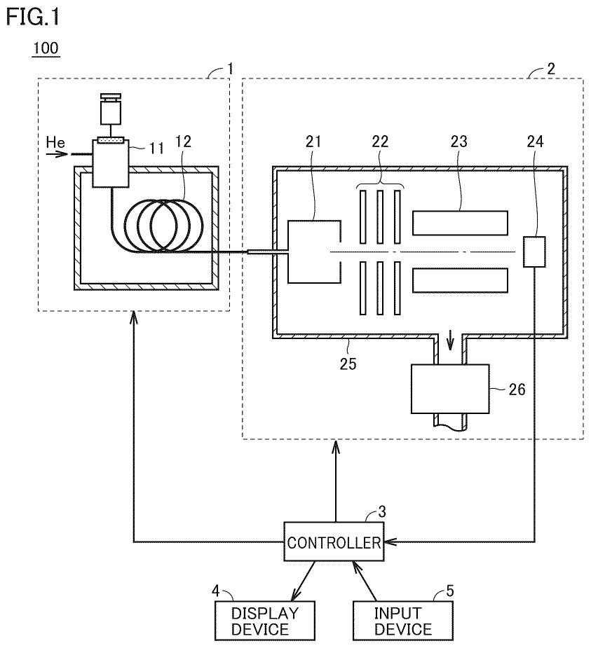

FIG. 1 is a diagram schematically showing an overall configuration of a GCMS apparatus 100 according to an embodiment. Referring to FIG. 1, GCMS apparatus 100 includes a GC portion 1, an MS portion 2, a controller 3, a display device 4, and an input device 5. Controller 3, display device 4, and input device 5 may be incorporated in MS portion 2. Alternatively, controller 3 may be a general-purpose computer provided at a position distant from GC portion 1 and MS portion 2. GCMS apparatus 100 can separate components contained in a sample and obtain detection intensity corresponding to each component.

GC portion 1 includes an injector 11 that introduces a sample and a column 12 where components in the sample introduced by injector 11 are separated. The sample is introduced by injector 11 into column 12 together with carrier gas (for example, helium).

The sample introduced into GC portion 1 is separated into components under a separation condition set by a user. The separation condition includes, for example, a flow velocity of carrier gas, a temperature of the column, a type of a stationary phase of the column, an inner diameter of the column, and a length of the column. Even identical components are different in time of elution from column 12 under different separation conditions.

MS portion 2 includes an ion source 21, an ion lens 22, a quadrupole filter 23, a detector 24, a vacuum container 25, and a vacuum pump 26. Ion source 21 ionizes components in the sample that has passed through column 12. Ion lens 22 converges ions ionized by ion source 21. Quadrupole filter 23 allows passage therethrough only of ions having a mass-to-charge ratio determined by an applied voltage, by controlling the applied voltage. Detector 24 detects ions that pass through quadrupole filter 23. The entire MS portion 2 is accommodated in vacuum container 25, and a pressure in vacuum container 25 is reduced by vacuum pump 26.

MS portion 2 detects ions based on a predetermined data collection condition. The data collection condition is set based on timing to start measurement and timing to quit measurement with elapsed time being defined as the reference as well as on a measurement method. Elapsed time is set, for example, with a time point of introduction of the sample into GC portion 1 by injector 11 being defined as 0. The measurement method performed in MS portion 2 includes scan measurement to repeatedly scan a mass number within a range of prescribed mass numbers and SIM measurement to selectively detect only ions having a specific mass number. The user selects the measurement method and sets the data collection condition for the measurement method.

More specifically, the collection condition refers to setting of an applied voltage to be applied to quadrupole filter 23 at a certain time point. The applied voltage applied to quadrupole filter 23 corresponds to a mass-to-charge ratio of ions detected by detector 24.

Controller 3 controls operation of each part of GCMS apparatus 100. Controller 3 is, for example, a general-purpose computer such as a desktop computer. A hardware configuration of controller 3 will be described later.

Display device 4 is implemented, for example, by a display and outputs information in accordance with an instruction from controller 3. The information includes, for example, information on the sample, a chromatogram, the mass-to-charge ratio of each component, ion intensity of each component, the separation condition, and the collection condition.

Input device 5 accepts input of information to controller 3. The information includes, for example, information on the sample, the separation condition, and the collection condition. Input device 5 is implemented, for example, by a mouse and a keyboard.

Controller 3, display device 4, and input device 5 may physically be integrated, for example, like a personal computer or a tablet.

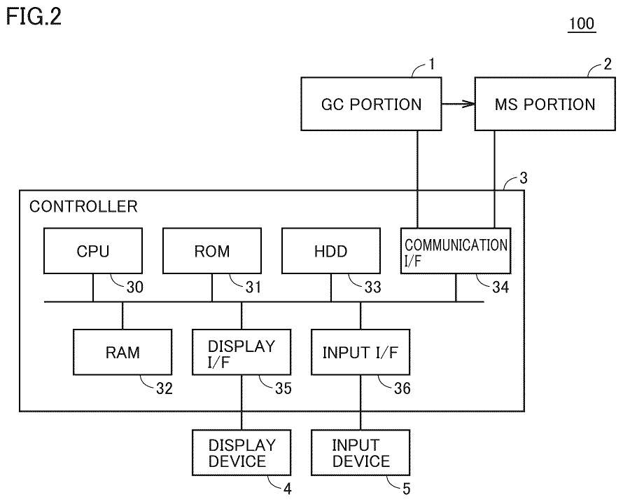

FIG. 2 is a diagram showing the hardware configuration of controller 3. The hardware configuration of controller 3 will be described with reference to FIG. 2.

Controller 3 includes, as main constituent elements, a central processing unit (CPU) 30, a read only memory (ROM) 31, a random access memory (RAM) 32, a hard disk drive (HDD) 33, a communication interface (I/F) 34, a display I/F 35, and an input I/F 36. The constituent elements are connected to one another through a data bus.

A program to be executed by CPU 30 can be stored in ROM 31. Data generated by execution of a program by CPU 30 and data inputted through communication I/F 34 can temporarily be stored in RAM 32, and RAM 32 can function as a primary storage. HDD 33 is a non-volatile storage, and information generated in GCMS apparatus 100 can be stored in a non-transitory manner. Controller 3 may include a semiconductor storage such as a flash memory and/or a solid state drive instead of or in addition to HDD 33.

Communication I/F 34 is an interface for communication with GC portion 1 and MS portion 2. Communication I/F 34 is implemented, for example, by a network adapter. Communication may be wireless communication by Bluetooth®, wireless local area network (LAN), or the like, or wired communication through a universal serial bus (USB).

### Comparative Example

In analysis of a sample with GCMS apparatus 100, prior to analysis, the user should set the separation condition in GC portion 1 and the collection condition in MS portion 2.

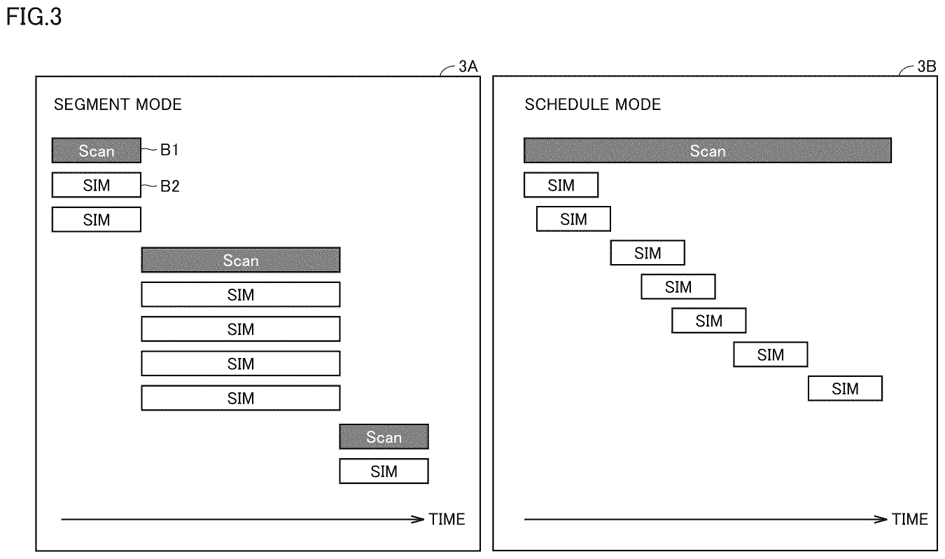

FIG. 3 is a diagram for illustrating a method of setting the collection condition in GCMS. In FIG. 3, each of a box B1 and a box B2 represents the collection condition. Each collection condition is selected for any one measurement method of scan measurement and SIM measurement, and defines timing to start measurement and timing to quit measurement. Box B1 represents an exemplary collection condition set for scan measurement and box B2 is an exemplary collection condition set for SIM measurement.

In general, in analysis of one sample with GCMS, a plurality of collection conditions are associated with a single separation condition. While the plurality of collection conditions overlap, measurement under the plurality of collection conditions is repeatedly conducted every prescribed time period. For example, while scan measurement, SIM measurement directed to components having the mass-to-charge ratio of 100, and SIM measurement directed to components having the mass-to-charge ratio of 200 overlap with one another, such a cycle that scan measurement is conducted, thereafter SIM measurement directed to the components having the mass-to-charge ratio of 100 is conducted for a prescribed time period, and thereafter SIM measurement directed to the components having the mass-to-charge ratio of 200 is conducted for a prescribed time period is repeated. A time period required for this cycle is, for example, 0.1 second.

FIG. 3 shows two charts 3A and 3B. Chart 3A shows a group of collection conditions referred to as a segment mode. Each box labeled with “Scan” represents the collection condition set for scan measurement, and each box labeled with “SIM” represents a period for which SIM measurement is conducted. A left end of the box indicates start timing in the collection condition and a right end of the box indicates end timing in the collection condition. In the segment mode, the plurality of collection conditions are set such that at least one SIM measurement is conducted while one scan measurement is conducted.

Chart 3B shows a group of collection conditions referred to as a schedule mode. In the schedule mode, the plurality of collection conditions are set such that scan measurement is conducted over the entire period during which at least one SIM measurement is conducted.

In general, accuracy in measurement by GCMS is in proportion to a time period allocated to measurement of components of interest. Therefore, in particular, in SIM measurement which is the measurement method directed to components having a specific mass-to-charge ratio, timing to start and timing to end SIM measurement are preferably set in conformity with time of elution of the components from GC portion 1 from a point of view of improvement in accuracy in measurement. The user sets the collection condition in conformity with the timing of elution of components to be measured.

In GCMS, the separation condition may be changed and time of appearance of peaks of identical components may be varied on a chromatogram. In such a case, the user should set again, timing to start measurement and timing to quit measurement in the collection condition, in conformity with the changed separation condition.

In order to reduce time for works by the user, a technology to automatically modify the collection condition associated with the separation condition at the time of change of the separation condition and to set again the collection condition corresponding to the new separation condition has been used.

Specifically, as disclosed in Japanese Patent Laying-Open No. 2006-322842, start timing and end timing in the collection condition are reset based on a retention time of a reference compound after change of the separation condition, with a temporal ratio to the reference compound is maintained. This method (a method of resetting start timing and end timing with the temporal ratio of the reference compound being maintained) is referred to as a “resetting method A” below.

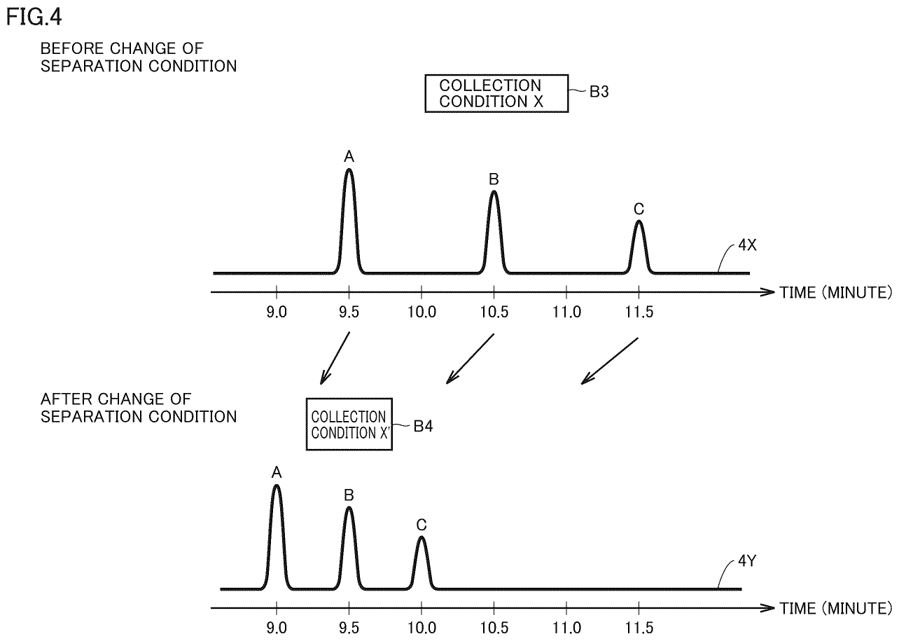

FIG. 4 is a diagram for illustrating resetting method A. In FIG. 4, a waveform 4X represents an exemplary chromatogram before change of the separation condition and a waveform 4Y represents an exemplary chromatogram after change of the separation condition. In FIG. 4, references A, B, and C represent respective peaks of reference compounds A, B, and C on the chromatogram.

In FIG. 4, a box B3 represents a measurement period defined by a collection condition X before change of the separation condition. Before change of the separation condition, as shown with box B3, data is collected during a period from 10.0 minutes to 11.0 minutes. The retention time of a compound A, on the other hand, is 9.5 minutes, the retention time of a compound B is 10.5 minutes, and the retention time of a compound C is 11.5 minutes. In other words, start timing indicated by box B3 is located intermediate between the retention times of compounds A and B and end timing indicated by box B3 is located intermediate between the retention times of compounds B and C.

A box B4 represents a measurement period expected by a data collection condition X′ reset with resetting method A after change of the separation condition. As the separation condition is changed, the retention time of compound A changes to 9.0 minutes, the retention time of compound B changes to 9.5 minutes, and the retention time of compound C changes to 10.0 minutes. As shown with box B4, since start timing in collection condition X′ set with resetting method A is a time point intermediate between the changed retention times of compounds A and B, it is set to 9.25 minutes. Similarly, end timing indicated by box B4 is set to 9.75 minutes.

As the collection condition is automatically set in conformity with change of the separation condition as described above, time for works involved with change of the collection condition by the user is made shorter. With the method above, however, setting of the collection condition may not be made as intended by the user.

For example, in FIG. 4, a period of collection of data in connection with box B3 is one minute, whereas the period of collection of data in connection with box B4 is 0.5 minute. In other words, the period of collection of data is made shorter by resetting. Consequently, some of components to be measured may be eluted during a period outside the period of collection of data. In other words, due to automatic setting of the collection condition with change of the separation condition with resetting method A, accuracy in measurement may be lower than accuracy before change of the separation condition.

A retention index may be used for estimation of predicted retention time. The retention index refers to a relative value which expresses retention time of a component as an index, based on a retention time of a peak of the reference compound. The retention index is not dependent on a flow rate of a mobile phase and a temperature of the column, unlike the retention time. The user can estimate the predicted retention time of a component to be measured, by making use of the retention index of the component to be measured and the retention time of the reference compound. The collection condition, however, may not be set as intended by the user, because the collection condition was automatically set based on the predicted retention time estimated with the use of the retention index by the user. In such a case, the period defined by timing to start and timing to quit measurement in the collection condition may deviate from timing of actual elution of components, and accuracy in measurement under the reset collection condition may be lower than accuracy under the collection condition before change. Therefore, a technology to reset the collection condition in conformity with the changed separation condition without the use of the retention index has been demanded.

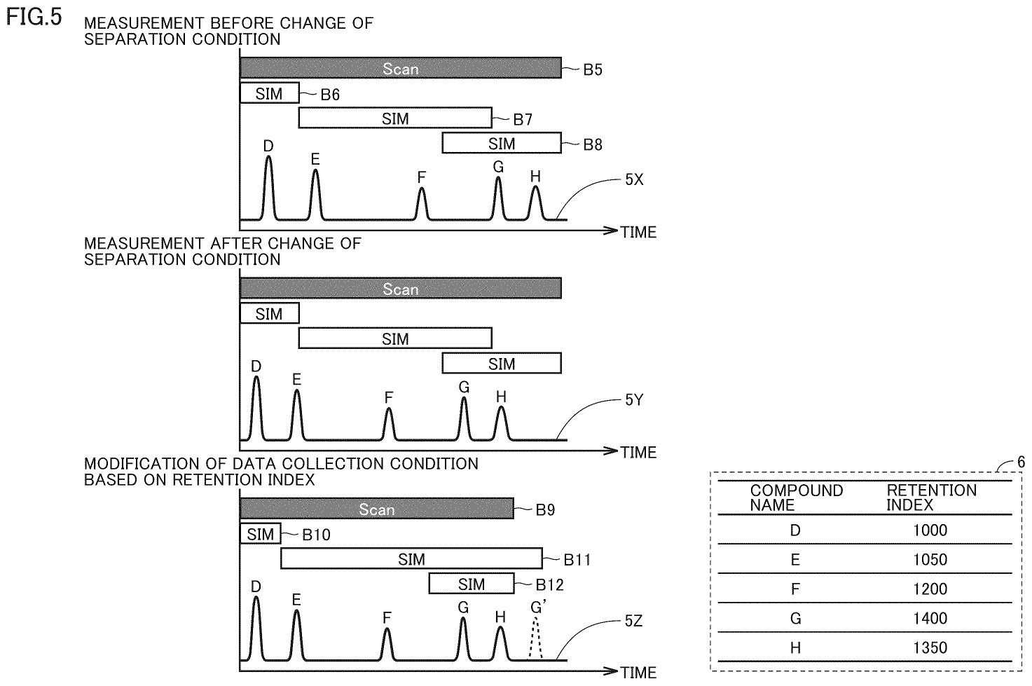

FIG. 5 is a diagram for illustrating the method of modifying the collection condition with the retention index. FIG. 5 shows with boxes B5 to B12, collection conditions set in separation of a sample containing compounds D to H under a prescribed separation condition.

More specifically, a waveform 5X represents a chromatogram obtained in analysis of the sample before change of the separation condition, and boxes B5 to B8 represent the collection conditions. Box B6 represents the collection condition under which compound D is to be measured. Box B7 represents the collection condition under which compounds E and F are to be measured. Box B8 represents the collection condition under which compounds G and H are to be measured. Box B5 then represents the collection condition defining that scan measurement is to be conducted during the whole measurement period covered by boxes B6 to B8. Scan measurement shown with box B5 can be defined as comprehensive measurement as compared with measurements shown with boxes B6 to B8.

A waveform 5Y represents a chromatogram obtained in analysis of the sample after change of the separation condition. With change of the separation condition, the retention times of compounds D to H are varied. For example, box B7 is directed to measurement of compounds E and F, however, as a result of the retention time of compound E becoming earlier, compound E is eluted before the timing to start measurement shown with box B7. In such a case, the collection condition should be modified in conformity with change of the separation condition.

A waveform 5Z represents a chromatogram obtained in analysis of the sample after change of the separation condition, and boxes B9 to B12 represent the collection conditions modified based on the predicted retention time calculated based on the retention index. A frame 6 represents the retention indices of compounds D to H.

In waveform 5Z, a solid line represents a chromatogram obtained in actual measurement of the sample and a dashed line represents a chromatogram predicted based on the retention index. Since the retention index of compound G is larger than the retention index of compound H as shown in frame 6, the predicted retention time of compound G is estimated to be located at a position shown with G′ provided to the waveform. Consequently, box B11 modified based on the predicted retention time of compound G is delayed in timing to quit measurement. Since box B9 is modified independently of the predicted retention time of compound G, end timing indicated by box B9 is set to precede end timing indicated by box B11. In such a case, in connection with box B9, scan measurement cannot be conducted over the whole measurement period covered by boxes B10 to B12, and the user is unable to obtain data by scan measurement for a desired period.

As a result of resetting of the collection condition with the retention index as described above, the actual retention time of the compound may deviate from the predicted retention time of the compound and the collection condition may not be set as intended by the user.

### [Data Processing Method According to Embodiment]

Then, in the data processing method according to the present embodiment, a first period from the timing to start measurement under the collection condition before change of the separation condition until the retention time of a component eluted first and a second period from the retention time of a component eluted last until the timing to quit measurement are defined. GCMS apparatus 100 then maintains the first period and the second period in the reset collection condition in resetting of the collection condition involved with change of the separation condition.

As the first period and the second period are thus maintained, the measurement period is set to cover the period of elution of a target component, and hence the target component can reliably be measured under the reset collection condition.

Such a collection condition as allowing comprehensive measurement during the whole measurement period under a plurality of collection conditions may be set. In such a case, in the data processing method according to the present embodiment, GCMS apparatus 100 sets timing to start and timing to quit comprehensive measurement so as to conduct comprehensive measurement during the whole measurement period under the plurality of reset collection conditions. Comprehensive measurement can thus be conducted during a period during which the user desires measurement, without the use of the retention index.

Contents in a plurality of types of processing included in the data processing method according to the present embodiment will be described as 1. to 5. below.

### <1. Acceptance of Collection Condition Before Change of Separation Condition>

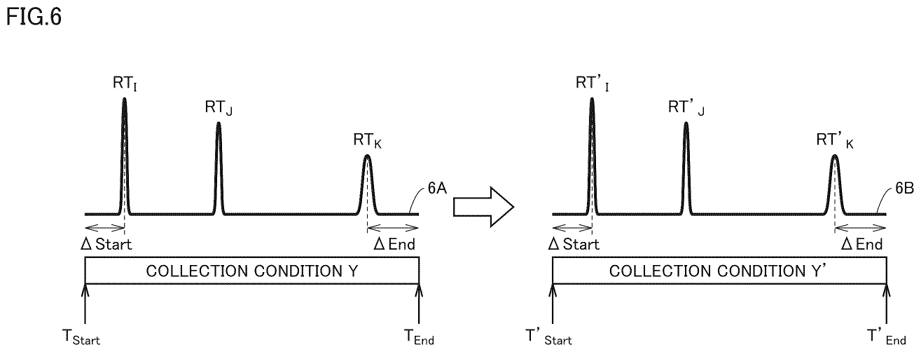

FIG. 6 is a diagram for illustrating a method of setting the collection condition in GCMS apparatus 100 with change of the separation condition. FIG. 6 shows a collection condition Y set before change of the separation condition and a collection condition Y′ set after change of the separation condition.

The collection condition before change of the separation condition will initially be described.

The collection condition before change of the separation condition includes timing to start measurement and timing to quit measurement. Components to be measured under the collection condition are associated by the user.

In FIG. 6, a waveform 6A represents an exemplary chromatogram before change of the separation condition and a waveform 6B represents an exemplary chromatogram after change of the separation condition. Collection condition Y accepted by GCMS apparatus 100 is set to start measurement at Tₛₜₐᵣₜ and quit measurement at T_{end}. Collection condition Y is directed to measurement of components I, J, and K. Retention time RT_{I} represents the retention time of component I. Retention time RT_{J} represents the retention time of component J. Retention time RT_{K} represents the retention time of component K. Each retention time is located between T_{Start} and T_{end}. Actually measured values are used as the retention times of components I, J, and K. In the present embodiment, the separation condition before change is an exemplary “first separation condition” and the separation condition after change is an exemplary “second separation condition.” In the present embodiment, collection condition Y is an exemplary “first collection condition.”

In GC portion 1, each component is separated to have a prescribed temporal length. Therefore, as shown in FIG. 6, in MS portion 2, each component is detected as a peak having a temporal length. Time corresponding to a portion highest in ion intensity in a peak (a top of the peak) is defined as the retention time. The retention time does not have to be indicated by the portion highest in ion intensity, and a portion of rise of the peak at which detection of the component starts or a portion of fall of the peak at which the component is no longer detected may be defined as the retention time.

### <2. Calculation of First Period and Second Period>

GCMS apparatus 100 calculates a difference between earliest time and the timing to start measurement, of the retention times of components to be measured. The difference is referred to as the first period. Furthermore, GCMS apparatus 100 calculates a difference between latest time and the timing to quit measurement, of the retention times of the components to be measured. The difference is referred to as the second period.

In FIG. 6, of the retention times of components I, J, and K to be measured under collection condition Y, the earliest retention time is retention time RT₁. Therefore, ΔStart which represents the difference between retention time RT₁ and Tₛₜₐᵣₜ corresponds to the first period. Of the retention times of components I, J, and K to be measured under collection condition Y, the latest retention time is retention time RT_{K}. Therefore, ΔEnd which represents the difference between retention time RT_{K} and T_{End} corresponds to the second period.

### <3. Prediction of Retention Time of Component to Be Measured Under Changed Separation Condition>

GCMS apparatus 100 measures a standard sample containing a reference compound under the changed separation condition. With the retention time of the reference compound obtained by measurement being defined as the index, the retention time of the component to be measured under an analysis condition is predicted. The retention time of the component to be measured under the analysis condition is calculated based on comparison between a result of measurement of the reference compound under the separation condition before change and a result of measurement of the component to be measured under the separation condition before change. The predicted retention time is referred to as the “predicted retention time” of the component to be measured.

In FIG. 6, predicted retention time RT′₁ of component I, predicted retention time RT′_{J} of component J, and predicted retention time RT′_{K} of component K under the changed separation condition are calculated.

### <4. Resetting of Collection Condition Under Changed Separation Condition>

GCMS apparatus 100 sets collection condition Y corresponding to the changed separation condition based on the predicted retention time of the component of interest in the collection condition.

Specifically, of the predicted retention times of components of interest under collection condition Y, a time point that goes back by the first period from the earliest predicted retention time is set as the start timing in collection condition Y. Of the predicted retention times of the components of interest under collection condition Y, a time point after lapse of the second period since the latest predicted retention time is set as the end timing in collection condition Y. The start timing in collection condition Y′ is not limited to the time point that goes back by the first period from the “earliest predicted retention time” described above, and it should only be a time point before that. The end timing in collection condition Y′ is not limited to the time point after lapse of the second period since the “latest predicted retention time” described above, and it should only be a time point after that.

In the example in FIG. 6, T′_{Start} is shown as the start timing in collection condition Y. T′_{Start} represents the time point that goes back by ΔStart from RT′₁ representing the earliest predicted retention time in the chromatogram obtained under the changed separation condition. T′_{End} is shown as the end timing in collection condition Y. T′_{End} represents the time point after lapse of ΔEnd since RT′_{K} representing the latest predicted retention time in the chromatogram obtained under the changed separation condition. In the present embodiment, collection condition Y′ is an exemplary “second collection condition.”

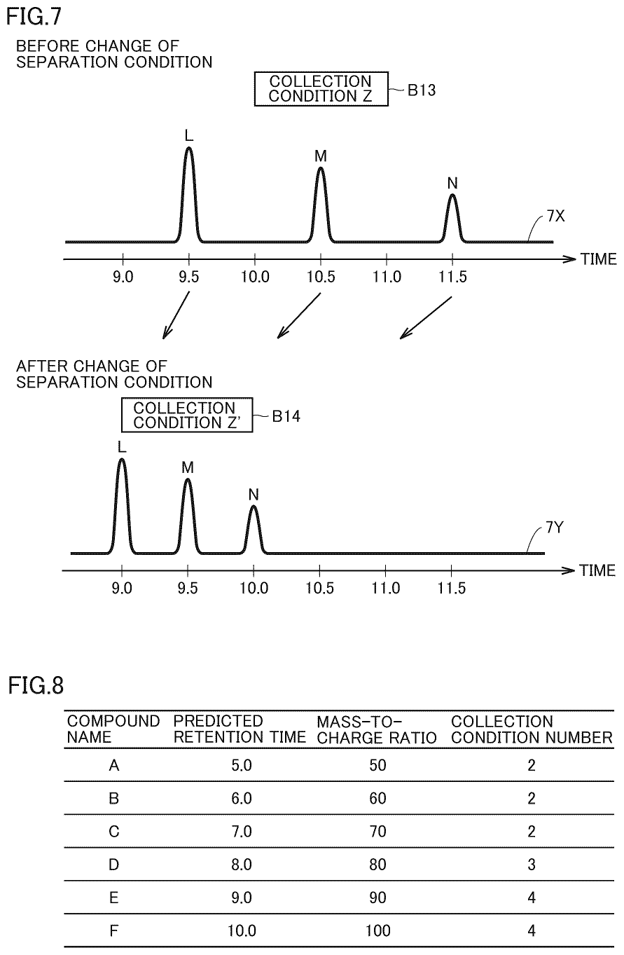

FIG. 7 is a diagram for illustrating a result of setting of a new collection condition with the method (which is referred to as a resetting method B below) of resetting the collection condition explained in 1. to 4. above. In FIG. 7, a waveform 7X represents an exemplary chromatogram before change of the separation condition and a waveform 7Y represents an exemplary chromatogram after change of the separation condition. In FIG. 7, references L and N represent respective peaks of reference compounds L and N on the chromatogram. A reference M in FIG. 7 represents the peak of a compound M on the chromatogram.

In FIG. 7, a box B13 represents a measurement period defined by a collection condition Z before change of the separation condition. Under collection condition Z, compound M is a component to be measured. Before change of the separation condition, as shown with box B13, data is collected during a period from 10.0 minutes to 11.0 minutes. Since the retention time of compound M is 10.5 minutes, the first period and the second period are each 0.5 minute.

A box B14 represents a measurement period expected under a data collection condition Z′ reset with resetting method B after change of the separation condition. With change of the separation condition, the retention time of reference compound L changes to 9.0 minutes and the retention time of reference compound N changes to 10.0 minutes. Therefore, based on relation between the retention times of reference compounds L and N before change of the separation condition and the retention time of compound M and change of retention times of reference compounds L and N, the predicted retention time of compound M under the changed separation condition is estimated as 9.5 minutes. Therefore, as shown with box B14, the start timing in collection condition Z′ set with resetting method B is set to 9.0 minutes which is a time point that goes back by the first period from 9.5 minutes and the end timing is set to 10.0 minutes which is a time point after lapse of the second period since 9.5 minutes.

In collection condition Z′ set based on resetting method B, the first period and the second period are held. Therefore, even after change of the separation condition, data can be collected while compound M is eluted.

For setting of the collection condition with resetting method B, each collection condition should be associated with a component to be measured. Therefore, in setting the collection condition, the user inputs the collection condition together with information on the component to be measured into GCMS apparatus 100. FIG. 8 is a diagram for illustrating information inputted by the user, in which a component to be measured and the collection condition are associated with each other.

As shown in FIG. 8, the predicted retention time and the mass-to-charge ratio of each compound and information on a number of a collection condition under which each compound is to be measured are inputted together with compound names which are names of compounds A to F which are components of interest. With the information, the collection condition is reset. For example, in resetting of a collection condition 2, the retention time, the first period, and the second period in the collection condition before change, of compounds A, B, and C and the predicted retention times in the changed collection condition, of compounds A, B, and C are used.

For example, as in scan measurement, a specific compound may not be associated with the collection condition. Information on the number of the collection condition may be erased from the information shown in FIG. 8 due to some trouble. When the collection condition and the component to be measured are thus not associated with each other, GCMS apparatus 100 resets the collection condition with resetting method A.

<5. Correction of Scan Measurement That Overlaps in Period with SIM Measurement>

When there are a plurality of collection conditions associated with a single separation condition, GCMS apparatus 100 determines whether or not there is a period during which scan measurement and SIM measurement overlap with each other. When there is such a period, GCMS apparatus 100 corrects timing to start and timing to quit reset scan measurement so as to cover a period of reset SIM measurement.

Specifically, for example, in the schedule mode shown in chart 3B in FIG. 3, the period during which one scan measurement is conducted includes seven periods of SIM measurement. Therefore, after each collection condition is reset, timing to start scan measurement is corrected to timing before earliest start timing in the reset SIM measurement. Timing to quit scan measurement is corrected to timing after the latest end timing in the reset SIM measurement. When the timing to start scan measurement and the timing to quit scan measurement have been set to the above-described timings before correction, there is no need for correction. In the present embodiment, collection conditions set for scan measurement before change of the separation condition are an exemplary “third collection condition” and an exemplary “fifth collection condition,” respectively. Collection conditions set for scan measurement after change of the separation condition are an exemplary “fourth collection condition” and an exemplary “sixth collection condition,” respectively.

In correction, the earliest start timing in SIM measurements preferably coincides with the timing to start scan measurement. In addition, the latest end timing in SIM measurements preferably coincides with the timing to quit scan measurement. This is because, when a period of scan measurement is set longer than necessary, time required for completion of scan measurement becomes longer and the number of samples that can be measured per unit time decreases.

### [Flow of Processing]

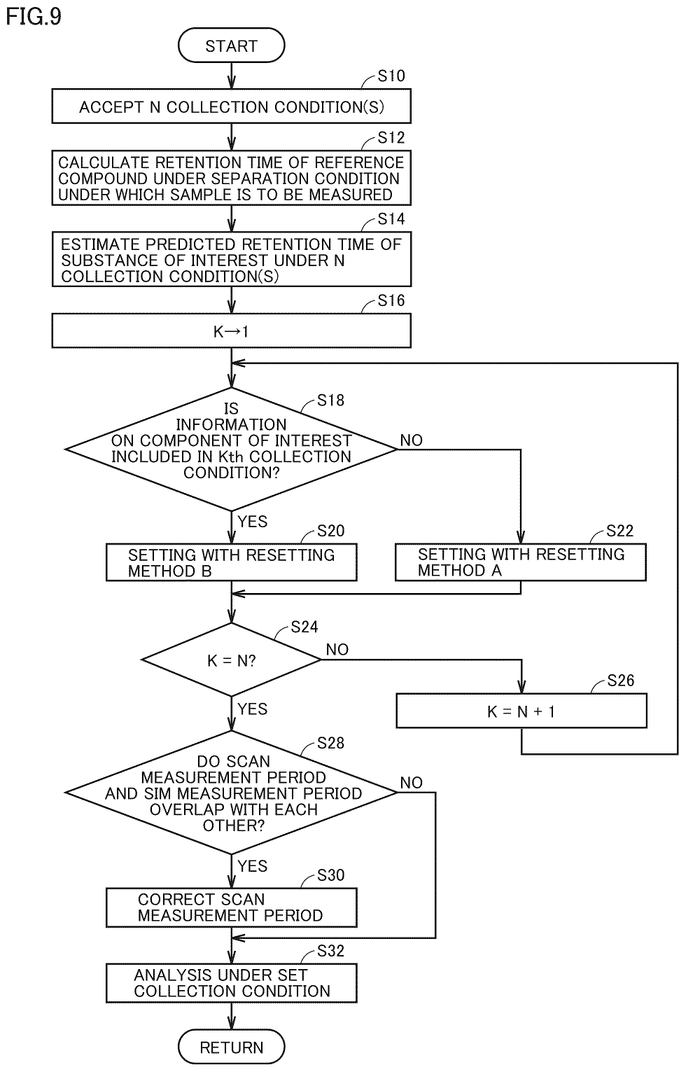

FIG. 9 is a flowchart showing data processing performed by CPU 30 in GCMS apparatus 100. In one implementation, sub routine processing in FIG. 9 is performed as being called from a main routine in execution of a given program by CPU 30 of GCMS apparatus 100.

In step S10, GCMS apparatus 100 accepts N (N being not smaller than 1) collection condition(s) associated with a prescribed separation condition from the user.

In step S12, GCMS apparatus 100 analyzes the standard sample containing the reference compound under the separation condition under which the user desires measurement of the sample, and obtains the retention time of the reference compound under the separation condition for measurement of the sample.

In step S14, GCMS apparatus 100 estimates the predicted retention time of the component to be measured under N collection condition(s) accepted in step S10, based on the retention time of the reference compound obtained in step S12.

In step S16, GCMS apparatus 100 sets a value of a variable K to be used in the processing in FIG. 9 to 1.

In step S18, GCMS apparatus 100 determines whether or not a Kth collection condition includes information on the component to be measured. When it is determined that the Kth collection condition includes the information on the component to be measured (YES in step S18), control proceeds to step S20, and otherwise (NO in step S18), control proceeds to step S22.

In step S20, GCMS apparatus 100 sets a new collection condition with resetting method B based on the Kth collection condition.

In step S22, GCMS apparatus 100 sets a new collection condition with resetting method A based on the Kth collection condition.

In step S24, GCMS apparatus 100 determines whether or not the value of variable K has reached N. When the value of variable K has reached N (YES in step S24), GCMS apparatus 100 has control proceed to step S28, and otherwise (NO in step S24), GCMS apparatus 100 has control proceed to step S26.

In step S26, GCMS apparatus 100 increments the value of variable K by one and has control return to step S18.

In step S28, GCMS apparatus 100 determines whether or not the period during which scan measurement is conducted overlaps with the period during which SIM measurement is conducted under N collection condition(s) accepted in step S10.

When it is determined that the period during which scan measurement is conducted overlaps with the period during which SIM measurement is conducted (Yes in step S28), control proceeds to step S30, and otherwise (NO in step S28), control proceeds to step S32.

In step S30, GCMS apparatus 100 corrects the timing to start corresponding scan measurement and the timing to quit corresponding scan measurement so as to cover the overlapping measurement periods of SIM measurements.

In step S32, GCMS apparatus 100 separates the sample under the changed separation condition and measures the separated component under the reset collection conditions. Thereafter, GCMS apparatus 100 quits the sub routine of data processing and has the process return to the main routine.

Under the control in accordance with the processing above, accuracy in measurement under the collection condition automatically set in association with the changed separation condition based on the collection condition associated with the separation condition before change in the case of change of the separation condition can be improved. Specifically, since the period from the start timing in the collection condition corresponding to the separation condition before change until the earliest retention time of the component to be measured and the period from the latest retention time of the component to be measured under the collection condition until the end timing are maintained also after resetting, the component to be measured can be prevented from being eluted during a period outside the period of collection of data.

In an example where scan measurement is set to be performed as overlapping with the period during which SIM measurement is performed, the timing to start scan measurement and the timing to quit scan measurement are modified such that scan measurement starts before the timing to start SIM measurement and scan measurement ends after the timing to quit SIM measurement. The user can thus set scan measurement to completely be conducted while SIM measurement is conducted. If the measurement periods of scan measurement and SIM measurement deviate from each other and there is a period during which only SIM measurement is conducted, during that period, only the component having the mass-to-charge ratio set in SIM measurement is measured. Therefore, the user may not be able to determine whether or not a component other than the component having the mass-to-charge ratio set in SIM measurement has been eluted. According to the modification method described above, since there is no period during which only SIM measurement is conducted, such a situation that the user is unable to determine whether or not there is a component other than the component having the mass-to-charge ratio set in SIM measurement can be prevented.

### [Aspects]

Illustrative embodiments described above are understood by a person skilled in the art as specific examples of aspects below.

(Clause 1) A data processing method according to one aspect sets based on a first collection condition associated with a first separation condition, a second collection condition associated with a second separation condition, for a chromatograph mass spectrometer that separates a sample containing one or more target components and collects data on the sample. The first collection condition includes a first start timing to start collection of the data and a first end timing to quit collection of the data. The first start timing is a time point that goes back by a first period from an earliest retention time, of retention times of the one or more target components under the first separation condition. The first end timing is a time point after lapse of a second period since a latest retention time, of the retention times. The second collection condition includes a second start timing to start collection of the data and a second end timing to quit collection of the data. The second start timing is timing to start collection of the data under the second collection condition. The second end timing is timing to quit collection of the data under the second collection condition. The data processing method includes calculating predicted retention times of the one or more target components under the second separation condition based on a result of separation of a standard sample under the second separation condition, setting timing before a first time point as the second start timing, the first time point being a time point that goes back by the first period from an earliest predicted retention time of the predicted retention times, setting timing after a second time point as the second end timing, the second time point being a time point after lapse of the second period since a latest predicted retention time of the predicted retention times, and causing the chromatograph mass spectrometer to separate the sample under the second separation condition and to collect data on the one or more target components under the second collection condition.

According to the data processing method described in Clause 1, in chromatograph mass spectrometry, the collection condition can automatically be reset in accordance with change of the separation condition, and accuracy in measurement under the changed separation condition can be improved.

(Clause 2) In the data processing method described in Clause 1, the second start timing may be the first time point and the second end timing is the second time point. According to the data processing method described in Clause 2, in chromatograph mass spectrometry, in resetting of the collection condition in accordance with change of the separation condition, a period of measurement under the reset collection condition can be set to be shortest. Therefore, the collection condition can be prevented from being set while a component to be measured is not eluted. The collection condition is set such that the measurement period is shortest, so that accuracy in measurement under other collection conditions can be improved.

(Clause 3) In the data processing method described in Clause 1 or 2, the chromatograph mass spectrometer may be a gas chromatograph mass spectrometer.

According to the data processing method described in Clause 3, in gas chromatograph mass spectrometry, the collection condition in a mass spectrometry portion can automatically be reset in accordance with change of the separation condition in a gas chromatograph, and accuracy in measurement under the changed separation condition can be improved.

(Clause 4) In the data processing method described in any one of Clauses 1 to 3, the second collection condition may be a condition for collection of data by selective ion monitoring measurement.

According to the data processing method described in Clause 4, in chromatograph mass spectrometry, the collection condition in SIM measurement can automatically be reset in accordance with change of the separation condition, and accuracy in measurement under the changed separation condition can be improved.

(Clause 5) In the data processing method described in any one of Clauses 1 to 4, a third collection condition under which a target component different from the one or more target components in the first collection condition is to be measured may be set in association with the first separation condition. The data processing method may further include setting, when a fourth collection condition under which a target component identical to the target component in the third collection condition is to be measured is set in association with the second separation condition, timing before the second start timing as the timing to start collection of data under the fourth collection condition.

According to the data processing method described in Clause 5, when the period during which measurement defined by the first collection condition is conducted overlaps with the period during which measurement defined by the third collection condition is conducted before change of the separation condition, timing to start measurement already determined in the reset fourth collection condition is corrected before timing to start measurement defined by the second collection condition reset after change of the separation condition. According to this correction, when the user desires measurement defined by the fourth collection condition to be conducted during the period during which measurement defined by the second collection condition is conducted, measurement defined by the second collection condition can be prevented from being conducted before start of measurement defined by the fourth collection condition.

(Clause 6) In the data processing method described in Clause 5, the timing to start collection of data under the fourth collection condition may coincide with the second start timing.

According to the data processing method described in Clause 6, correction can be made such that the timing to start measurement defined by the fourth collection condition coincides with the timing to start measurement defined by the second collection condition.

(Clause 7) In the data processing method described in Clause 5 or 6, the third collection condition and the fourth collection condition may be conditions for collection of data by scan measurement.

According to the data processing method described in Clause 7, when the period during which SIM measurement is conducted overlaps with the period during which scan measurement is conducted before change of the separation condition, timing to start reset scan measurement is corrected before timing of start of the period of SIM measurement reset after change of the separation condition. According to this correction, when the user desires scan measurement to be conducted during the period during which SIM measurement is conducted, SIM measurement can be prevented from being conducted before start of scan measurement.

(Clause 8) In the data processing method described in any one of Clauses 1 to 7, a fifth collection condition under which a target component different from the one or more target components in the first collection condition is to be measured may be set in association with the first separation condition. The data processing method may further include setting, when a sixth collection condition under which a target component identical to the target component in the fifth collection condition is to be measured is set in association with the second separation condition, timing after the second end timing as the timing to quit collection of data under the sixth collection condition.

According to the data processing method described in Clause 8, when the period during which measurement defined by the first collection condition is conducted overlaps with the period during which measurement defined by the fifth collection condition is conducted before change of the separation condition, timing to quit measurement already determined in the reset sixth collection condition is corrected after timing to quit measurement defined by the second collection condition reset after change of the separation condition. According to this correction, when the user desires measurement defined by the sixth collection condition to be conducted during the period during which measurement defined by the second collection condition is conducted, measurement defined by the second collection condition can be prevented from being conducted after end of measurement defined by the sixth collection condition.

(Clause 9) In the data processing method described in Clause 8, the timing to quit collection of data under the sixth collection condition may coincide with the second end timing.

According to the data processing method described in Clause 9, correction can be made such that timing to quit measurement defined by the sixth collection condition coincides with timing to quit measurement defined by the second collection condition.

(Clause 10) In the data processing method described in Clause 8 or 9, the fifth collection condition and the sixth collection condition may be conditions for collection of data by scan measurement.

According to the data processing method described in Clause 10, when the period during which SIM measurement is conducted overlaps with the period during which scan measurement is conducted before change of the separation condition, timing to quit reset scan measurement is corrected after timing to quit SIM measurement reset after change of the separation condition. According to this correction, when the user desires scan measurement to be conducted during the period during which SIM measurement is conducted, SIM measurement can be prevented from being conducted after end of scan measurement.

(Clause 11) A computer readable medium according to one aspect is a non-transitory computer readable medium having a program recorded thereon, the program being executed by a processor mounted on a computer. The program, by being executed by the processor, may cause the computer to perform accepting a first collection condition, the first collection condition being a data collection condition under a first separation condition, the first collection condition including a first start timing to start collection of data and a first end timing to quit collection of data, the first start timing being a time point that goes back by a first period from an earliest retention time, of retention times of the one or more target components under the first separation condition, the first end timing being a time point after lapse of a second period since a latest retention time, of the retention times, calculating predicted retention times of the one or more target components under a second separation condition based on a result of separation of a standard sample under the second separation condition, setting timing before a first time point as the second start timing, the first time point being a time point that goes back by the first period from an earliest predicted retention time of the predicted retention times, the second start timing being timing to start collection of the data under the second collection condition associated with the second separation condition, and setting timing after a second time point as the second end timing, the second time point being a time point after lapse of the second period since a latest predicted retention time of the predicted retention times, the second end timing being timing to quit collection of the data under the second collection condition.

According to the computer readable medium described in Clause 11, in chromatograph mass spectrometry, the collection condition can automatically be reset in accordance with change of the separation condition, and accuracy in measurement under the changed separation condition can be improved.

(Clause 12) An information processing apparatus according to one aspect is an information processing apparatus including at least one processor and the computer readable medium described in Clause 11. The processor may be configured to execute a program stored in the computer readable medium.

According to the information processing apparatus described in Clause 12, in chromatograph mass spectrometry, the collection condition can automatically be reset in accordance with change of the separation condition, and accuracy in measurement under the changed separation condition can be improved.

(Clause 13) A gas chromatograph mass spectrometer according to one aspect is a gas chromatograph mass spectrometer that sets based on a first collection condition which is a data collection condition for collection of data on one or more target components under a first separation condition, a second collection condition and collects data, the second collection condition being a data collection condition under a second separation condition under which a sample containing the one or more target components is to be analyzed. The first collection condition includes a first start timing to start collection of the data and a first end timing to quit collection of the data. The first start timing is a time point that goes back by a first period from an earliest retention time, of retention times of the one or more target components under the first separation condition. The first end timing is a time point after lapse of a second period since a latest retention time, of the retention times, The second collection condition includes a second start timing to start collection of the data and a second end timing to quit collection of the data. The second start timing is timing to start collection of the data under the second collection condition. The second end timing is timing to quit collection of the data under the second collection condition. The gas chromatograph mass spectrometer includes a gas chromatograph, a mass spectrometer that conducts mass spectrometry of a component separated by the gas chromatograph, and a controller that controls the gas chromatograph and the mass spectrometer. The gas chromatograph is configured to separate a standard sample containing an already-known prescribed component under the second separation condition. The mass spectrometer is configured to analyze the prescribed component and obtain a chromatogram. The controller is configured to calculate predicted retention times of the one or more target components under the second separation condition based on a result of separation of the standard sample under the second separation condition, to set timing before a first time point as the second start timing, the first time point being a time point that goes back by the first period from an earliest predicted retention time of the predicted retention times, to set timing after a second time point as the second end timing, the second time point being a time point after lapse of the second period since a latest predicted retention time of the predicted retention times, and to cause the gas chromatograph to separate the sample into components under the second separation condition and to obtain data on the one or more target components under the second collection condition.

According to the gas chromatograph mass spectrometer described in Clause 13, in chromatograph mass spectrometry, the collection condition can automatically be reset in accordance with change of the separation condition, and accuracy in measurement under the changed separation condition can be improved.

Though an embodiment of the present invention has been described, it should be understood that the embodiment disclosed herein is illustrative and non-restrictive in every respect. The scope of the present invention is defined by the terms of the claims and is intended to include any modifications within the scope and meaning equivalent to the terms of the claims.

What is claimed is:

1. A data processing method of setting based on a first collection condition associated with a first separation condition, a second collection condition associated with a second separation condition, for a chromatograph mass spectrometer that separates a sample containing one or more target components and collects data on the sample,
the first collection condition including a first start timing to start collection of the data and a first end timing to quit collection of the data,
the first start timing being a time point that goes back by a first period from an earliest retention time, of retention times of the one or more target components under the first separation condition,
the first end timing being a time point after lapse of a second period since a latest retention time, of the retention times,
the second collection condition including a second start timing to start collection of the data and a second end timing to quit collection of the data,
the second start timing being timing to start collection of the data under the second collection condition,
the second end timing being timing to quit collection of the data under the second collection condition,
the data processing method comprising:
calculating predicted retention times of the one or more target components under the second separation condition based on a result of separation of a standard sample under the second separation condition;
setting timing before a first time point as the second start timing,
the first time point being a time point that goes back by the first period from an earliest predicted retention time of the predicted retention times,
setting timing after a second time point as the second end timing,
the second time point being a time point after lapse of the second period since a latest predicted retention time of the predicted retention times; and
causing the chromatograph mass spectrometer to separate the sample under the second separation condition and to collect data on the one or more target components under the second collection condition.

2. The data processing method according to claim 1, wherein
the second start timing is the first time point, and
the second end timing is the second time point.

3. The data processing method according to claim 1, wherein
the chromatograph mass spectrometer is a gas chromatograph mass spectrometer.

4. The data processing method according to claim 1, wherein
the second collection condition is a condition for collection of data by selective monitoring measurement.

5. The data processing method according to claim 1, wherein
a third collection condition under which a target component different from the one or more target components in the first collection condition is to be measured is set in association with the first separation condition, and
the data processing method further comprises setting, when a fourth collection condition under which a target component identical to the target component in the third collection condition is to be measured is set in association with the second separation condition, timing before the second start timing as the timing to start collection of data under the fourth collection condition.

6. The data processing method according to claim 5, wherein
the timing to start collection of data under the fourth collection condition coincides with the second start timing.

7. The data processing method according to claim 5, wherein
the third collection condition and the fourth collection condition are conditions for collection of data by scan measurement.

8. The data processing method according to claim 1, wherein
a fifth collection condition under which a target component different from the one or more target components in the first collection condition is to be measured is set in association with the first separation condition, and
the data processing method further comprises setting, when a sixth collection condition under which a target component identical to the target component in the fifth collection condition is to be measured is set in association with the second separation condition, timing after the second end timing as the timing to quit collection of data under the sixth collection condition.

9. The data processing method according to claim 8, wherein
the timing to quit collection of data under the sixth collection condition coincides with the second end timing.

10. The data processing method according to claim 8, wherein
the fifth collection condition and the sixth collection condition are conditions for collection of data by scan measurement.

11. A non-transitory computer readable medium having a program recorded thereon, the program being executed by a processor mounted on a computer, the program, by being executed by the processor, causing the computer to perform:
accepting a first collection condition, the first collection condition being a data collection condition under a first separation condition,
the first collection condition including a first start timing to start collection of data and a first end timing to quit collection of data,
the first start timing being a time point that goes back by a first period from an earliest retention time, of retention times of the one or more target components under the first separation condition,
the first end timing being a time point after lapse of a second period since a latest retention time, of the retention times;
calculating predicted retention times of the one or more target components under a second separation condition based on a result of separation of a standard sample under the second separation condition;
setting timing before a first time point as the second start timing,
the first time point being a time point that goes back by the first period from an earliest predicted retention time of the predicted retention times,
the second start timing being timing to start collection of the data under the second collection condition associated with the second separation condition; and
setting timing after a second time point as the second end timing,
the second time point being a time point after lapse of the second period since a latest predicted retention time of the predicted retention times,
the second end timing being timing to quit collection of the data under the second collection condition.

12. An information processing apparatus comprising:
at least one processor; and
the computer readable medium according to claim 11, wherein
the processor is configured to execute a program stored in the computer readable medium.

13. A gas chromatograph mass spectrometer that sets based on a first collection condition which is a data collection condition for collection of data on one or more target components under a first separation condition, a second collection condition and collects data, the second collection condition being a data collection condition under a second separation condition under which a sample containing the one or more target components is to be analyzed,
the first collection condition including a first start timing to start collection of the data and a first end timing to quit collection of the data,
the first start timing being a time point that goes back by a first period from an earliest retention time, of retention times of the one or more target components under the first separation condition,
the first end timing being a time point after lapse of a second period since a latest retention time, of the retention times,
the second collection condition including a second start timing to start collection of the data and a second end timing to quit collection of the data,
the second start timing being timing to start collection of the data under the second collection condition,
the second end timing being timing to quit collection of the data under the second collection condition,
the gas chromatograph mass spectrometer comprising:
a gas chromatograph;
a mass spectrometer that conducts mass spectrometry of a component separated by the gas chromatograph; and
a controller that controls the gas chromatograph and the mass spectrometer, wherein
the gas chromatograph is configured to separate a standard sample containing an already-known prescribed component under the second separation condition,
the mass spectrometer is configured to analyze the prescribed component and obtain a chromatogram, and
the controller is configured to
calculate predicted retention times of the one or more target components under the second separation condition based on a result of separation of the standard sample under the second separation condition,
set timing before a first time point as the second start timing,
the first time point being a time point that goes back by the first period from an earliest predicted retention time of the predicted retention times,
set timing after a second time point as the second end timing,
the second time point being a time point after lapse of the second period since a latest predicted retention time of the predicted retention times, and
cause the gas chromatograph to separate the sample into components under the second separation condition and to obtain data on the one or more target components under the second collection condition.
